(19) United States
(12) Patent Application Publication
(10) Pub. No.: US 2010/0268767 A1
(43) Pub. Date: Oct. 21, 2010

(54) System and Method for Information Retrieval from a Context Aware Mechanism

(75) Inventors: Brian Edward McColgan, Toronto (CA); Gaelle Martin-Cocher, Toronto (CA)

Correspondence Address: Research in Motion Corp./CR;Attn: J. Robert Brown, 5601 Granite Parkway, Suite 750, Plano, TX, 75024, US

(73) Assignee: RESEARCH IN MOTION LIMITED, Waterloo (CA)

(21) Appl. No.: 12/752,954

(22) Filed: Apr. 1, 2010

Related U.S. Application Data
(60) Provisional application No. 61/168,110, filed on Apr. 9, 2009.

(51) Int. Cl. G06F 15/16

(52) U.S. Cl. 709/203

(57) ABSTRACT

A method relating to qualifying presence data. A qualifier is received. The qualifier is applied to first presence data in conjunction with applying at least one of a filter, a policy, a presence context data and a partial notify to the first presence data to generate second presence data. The second presence data is sent to a requestor.

### CROSS-REFERENCE TO RELATED APPLICATIONS

The present application claims priority to U.S. provisional patent application No. 61/168,110 filed Apr. 9, 2009, by Brian McColgan, et al, entitled “System and Method for Information Retrieval from a Context Aware Mechanism” (34888-US-PRV-4214-15400), which is incorporated by reference herein as if reproduced in its entirety.

### BACKGROUND

Some user agents (UAs), such as mobile telecommunications devices, can collect presence information associated with the user of the user agent. The presence information might include the user's location, the user's availability, the user's willingness to communicate, the user's willingness to use a particular service or communication method, the user's state of mind, activities the user is currently engaged in, applications currently executing on the user's UA, and similar data that relates to the current state of the user and/or the UA. An entity that has presence information associated with it, such as a human user of a UA, can be referred to as a presentity. A presentity might also be a non-human entity, such as an application executing on a UA. An entity that provides presence information on behalf of one or more presentities can be referred to as a presence source. For example, a UA that provides presence information associated with its user could be a presence source. When a presence source is associated with only one presentity, the presence source and the presentity could be considered equivalent.

A presence source that has collected presence information about a presentity might transmit the presence information to an entity that can be referred to as a presence server. The presence server might then provide the presence information to an entity that wishes to consume the presence information. This entity can be referred to as a watcher or logical observer. As an example, if a presentity “Bob” has consented to allow other users to have access to information about his current location, Bob's UA might transmit his location information to a presence server. If a watcher “Alice” wished to learn Bob's current location, Alice's UA might submit an appropriate request to the presence server, and the presence server might send presence information about Bob to Alice's UA. Alice's UA might then process the presence information to determine Bob's location.

As used herein, the terms “user agent” and “UA” might in some cases refer to mobile devices such as mobile telephones, personal digital assistants, handheld or laptop computers, and similar devices that have telecommunications capabilities. Such a UA might include a UA device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UA might include the UA device itself without such a module. In other cases, the term “UA” might refer to devices that have similar capabilities but are not transportable, such as desktop computers, set-top boxes, or network appliances. The term “UA” can also refer to any hardware or software component that can terminate a communication session for a user. Also, the terms “user agent,” “UA,” “user equipment,” “UA,” “user device” and “user node” might be used synonymously herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a communications system according to an embodiment of the disclosure.

FIG. 2 is a block diagram of a communications system according to an alternative embodiment of the disclosure.

FIG. 3 is a block diagram of a communications system according to an alternative embodiment of the disclosure.

FIG. 4 is a flow chart of a method for processing context data in a context aware mechanism according to an embodiment of the disclosure.

FIG. 5 illustrates a system that includes a processing component of a device, such as a user agent, suitable for implementing one or more embodiments disclosed herein.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated herein, but may be modified within the scope of the appended claims along with their full scope of equivalents.

The embodiments are directed generally to methods and devices for tracking, manipulating, and disseminating presence data. Presence data relates to information concerning where a person is, whether the person is available, a manner in which the person can be contacted, and/or other such information. The embodiments described herein provide direct or derived qualifiers on what, when, where, how and to whom presence data is transmitted. As explained further below, examples of qualifiers include time-based qualifiers, frequency-based qualifiers, level-of-interest based qualifiers, level-of-priority qualifiers, incremental-versus-new qualifiers, and many others.

In particular, the embodiments provide for a processor configured to provide context data to a context aware mechanism. The context data comprises at least one of presentity context data and watcher context data. The context data further comprises a qualifier selected from the group consisting of one or more of a time qualifier, a frequency qualifier, and an incremental versus new qualifier.

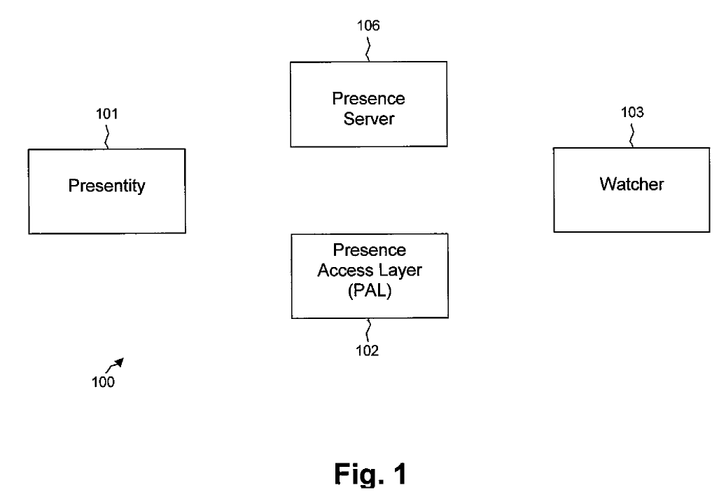

FIG. 1 is a block diagram of an embodiment of a system 100 that includes one or more presentities 101, one or more watchers 103, and a presence server 106. In some cases, a presence access layer (PAL) 102, as described below, might also be present. The PAL 102 might reside wholly or partially in the presence server 106, in the presentity 101, in the watcher 103, in one or more services or applications, and/or in one or more other network components. The functionality provided by the PAL 102 may be divided between these and/or other components. Alternatively, the PAL 102 might be a standalone component.

As mentioned above, the presentity 101 might be a human or non-human entity with which presence information is associated. The presentity 101 might reside wholly or partially on a UA or wholly or partially in a network or on a network component. Although not shown, multiple presence sources that capture presence information on behalf of the presentity 101 might be present. Multiple presentities 101 might also be present, and a single presence source might be associated with multiple presentities 101 and/or a single presentity 101 might be associated with multiple presence sources. Hereinafter, the term “presentity” might refer only to one or more presentities 101 or might refer to one or more presentities 101 and one or more associated presence sources. That is, no distinction will be made between a presentity and a presence source, but it should be understood that in some cases these can be separate entities.

The logical observer or watcher 103 might be one or more humans, applications, services, or other entities that monitor or wish to consume presence information associated with the presentity 101. When the watcher 103 is an application or a service, the application or service might be wholly or partially resident on a UA. Alternatively, the application or service might be wholly or partially resident on a network component such as a server (e.g., an application server). Hereinafter, the term “watcher” might refer to a human, an application, or a service interested in presence information, to a UA or network component on which such an application or service resides, or to any combination of these entities.

The presentity 101 might be able to define (for example, using Presence Subscription Rules which includes Subscription Authorization Rules and Subscription Content Rules) which watchers 103 can receive the presentity's presence information and which presence information the watchers 103 can receive. As an example, the presentity user “Bob” might specify that all of his work supervisors can receive all of his presence information. He might also specify that the watcher “Alice” can receive a subset of his presence information, particularly presence information about his current willingness to communicate, but can receive none of his other presence information, such as his current location. Alternatively or in combination with the above, another entity, such as Bob's employer, might designate which elements of Bob's presence information will be made available to which watchers 103. This embodiment may also apply to a service provider, or a principal administrator of a presence platform, where the service provider or the principal administrator specifies what elements can be shared.

A plurality of applications or services, such as instant messaging services or push-to-talk services, might be associated with the presentity 101, and these applications or services might be provided by one or more devices. The presentity 101 might publish presence information from a plurality of these devices. For example, Bob might be using a desktop computer and a handheld telephone simultaneously and may be considered available on either device. If Bob did not use the computer for an extended period of time, the computer might enter a sleep mode, and Bob might become unavailable on that device. However, he might remain available on the handheld telephone.

The presentity 101 can publish its presence information to the presence server 106. Only certain portions of the presence information might be made available to the watchers 103, and only certain watchers 103 might have access to the presence information. The presentity 101 or a third party (for example, a service provider or administrator) might publish rules or policies to the presence server 106 that define the portions of the presence information that will be made available to the watchers 103 and which of the portions will be made available to which of the watchers 103. The rules or polices might be established for groups of presentities 101 and/or groups of watchers 103. The rules or polices might be provided to the presence server 106 in a policy document. Alternatively, the presence information that will be made available to a particular watcher 103 might be determined at the time that watcher 103 requests presence information, possibly in combination with other factors. For example, a policy may be used to further narrow the presence information distributed at request time.

As used herein, the term “rule” refers to a sequence of logic that, when executed, can specify actions. The term “policy” refers to logic that can aid in the evaluation of a rule by, for example, providing hints or guidance, clarifying indeterminate or inconclusive scenarios during processing, or providing parameters. A distinction might also be made between a rule and a base rule and between a policy and a base policy. A base rule is typically a common interoperable rule or a default rule. That is, a base rule is a rule that is specified when no specific service or platform has overridden or changed it. Therefore, the term “rule” could refer to any rule, base or otherwise. Similarly, the term “policy” could refer to the set of all policies, and the term “base policy” could refer to a common or default policy that is used when a policy has not been overridden, extended, or enhanced.

The presence server 106 is a network component that receives presence information from the presentity 101 and provides presence information to the watcher 103. The rules or policies that define the presence information that will be made available to the watchers 103 might be stored on and/or processed by the presence server 106. When the watcher 103 wishes to receive presence information associated with the presentity 101, the watcher 103 can send a request to the presence server 106. The presence server 106 can then determine if the watcher 103 is authorized to receive the presentity's presence information. If the watcher 103 is authorized, the presence server 106 sends the presence information to the watcher 103.

Upon receiving the presence document, the watcher 103 parses the XML or other encoding scheme to extract the desired presence information. The entire presence document is typically parsed, regardless of the amount of presence information that is sought. For example, if the watcher 103 wished to learn the presentity's current willingness to communicate, the watcher 103 might need to sift through large amounts of unrelated data, such as the presentity's location, the presentity's willingness to use a particular service, the applications currently executing on the presentity's UA, and other information, to find the single data element that is desired.

In some cases, the watcher 103 might wish to learn a combination of information about the presentity 101. For example, if the watcher 103 wanted to send an instant message to the presentity 101, the watcher 103 might first attempt to determine the presentity's willingness to communicate and whether an instant messaging application is currently executing on the presentity's UA. In such cases, the watcher 103 might again send a single request for presence information to the presence server 106 and might again receive the entire presence document. The watcher 103 would then parse the entire document to find the plurality of data elements that are desired and perform the appropriate logical operations to correlate the data elements and derive the combination of information that was desired.

It may be possible that the presentity 101 did not specify whether or not the watcher 103 could have access to a data element that the watcher 103 is trying to obtain. It may also be possible that the presentity did not publish the data element, in which case the data element is missing or may not be available. In that case, the presence document may not contain the information that the watcher 103 is seeking. In such a case, the results of the watcher's parsing of the presence document may be indeterminate and the further actions the watcher 103 should take may not be clear.

In some cases, the system 100 may be configured with PAL 102 such that more efficient processing and dissemination of presence information is provided. The PAL 102 can abstract and simplify complex presence information by subscribing to the Presence Server 106 for presence information of presentity 101 on behalf of the watcher 103. That is, the PAL 102 can act as a proxy for the watcher 103 by: receiving a presence information request from the watcher 103; sending the subscription/subscribe request to the presence server 106; receiving a presence document from the presence server 106; parsing the information in the presence document; and returning to the watcher 103 a single value, such as “true” or “false”, as a response to the presence information request.

The PAL 102 allows the watcher 103 to submit a request for a single element of presence information, which can be referred to as a presence aspect. In addition, the presence aspect or aspects may represent simple presence information elements, such as availability, or more complex indications based on the correlated abstractions, as described above. For example, the presentity's willingness to communicate might be a presence aspect, the presentity's current location might be another, the presentity's preferred means of communication might be another, and so on. The presence aspects are reusable, interoperable abstractions that can be applicable across a plurality of applications or services. The watcher 103 can send a message to the PAL 102 specifying a single presence aspect for which the watcher 103 is seeking information. The PAL 102 can then respond with information related only to that presence aspect such that the watcher 103 need not parse, process or otherwise deal with a presence document.

As an example, if the watcher 103 wishes to learn whether the presentity 101 is currently willing to communicate, the watcher 103 can submit a request to the PAL 102 for information specifically about presence aspect willingness. If the presentity 101 has specified that the watcher 103 can have access to the presentity's willingness information, the PAL 102 can respond with a single value indicating the presentity's willingness or unwillingness to communicate (e.g. willing is ‘true’ or unwilling is ‘false’). The watcher 103 then needs to process only this single value. This can be contrasted with the situation where the PAL 102 is not present. In that case, the watcher 103 would ask for presence information in general, receive the entire presence document, and parse the presence document to determine the willingness aspect.

The PAL 102 can also process more complex requests from the watcher 103. For example, if the watcher 103 wished to determine a combination of information associated with the presentity 101, the watcher 103 might send the PAL 102 a request for each desired presence aspect. The PAL 102 might then return a response for each of the requests. Alternatively, the PAL 102 might correlate multiple presence aspects and return a single value to the watcher 103 that represents the combination of information that the watcher 103 was seeking.

In addition to greatly simplifying the manner in which the watcher 103 requests, receives, and processes presence information, use of the PAL 102 allows processing that might previously have been performed by the watcher 103 to be offloaded to the PAL 102. In the cases where the PAL 102 is a standalone component or resides wholly or partially in the presence server 106 or some other network component, offloading the processing of presence information to the PAL 102 can free some of the processing capabilities of the watcher 103 for other purposes. An example of ‘other purposes’ could be fulfilling core functions of a presence aware application, such as media sharing in an instant messaging application.

The PAL 102 may also process presence information on behalf of multiple applications or services that might otherwise redundantly perform the same presence information processing. That is, multiple applications or services might reside on or be available to the watcher 103, and each might have the capability to request, receive, and process presence information. Many of the steps that the applications or services take with regard to the presence information might be common to several of the applications or services. For example, there may be common presence-related rules or logic that would apply to both an instant messaging service and a push-to-talk service. If the PAL 102 is not present, each of these services might perform the common steps separately. If the PAL 102 is present, the PAL 102 can perform the common steps on behalf of each of these services and then return the results of the processing to the services. This can allow common procedures to occur only one time, thus increasing the efficiency of the watcher 103 and the applications or services it uses.

The PAL 102 can also ensure that indeterminate results are not returned to the watcher 103. As mentioned previously, if the watcher 103 seeks information about a presence aspect for which the presentity 101 has not provided information, the watcher's parsing of the presence document to determine that information might be inconclusive. The PAL 102, however, can contain functionality that specifies a definitive response to a presence information request even when information about the requested presence aspect is not available. For example, if the presentity 101 has not specified a willingness or an unwillingness to communicate, and if the watcher 103 submits a request for the presentity's willingness presence aspect, the PAL 102 might provide a default willingness value to the watcher 103. This default value may be associated as part of a rule and may also incorporate a policy type/value. Further, the value of the policy may be set based on the service, or may be changed or overridden by a PAL administrator, a service provider, or some other authorized user principal. In an example, the PAL 102 might indicate that the presentity 101 is unwilling to communicate for an indefinite period of time. In this way, the watcher 103 can be assured of receiving a usable response to any presence information request.

While the above discussion has focused on the PAL 102 providing presence information to the watcher 103 in response to the watcher's request for the current status of that information, the PAL 102 might also provide presence information based on a trigger defined by the watcher 103. That is, the watcher 103 might specify that it wishes to be informed when a change occurs in a presence aspect. When the PAL 102 detects that the specified change has occurred based on established rules and/or context (such as presence context), the PAL 102 can notify the watcher 103 of the change. A trigger might apply to a presence aspect alone or to a presence aspect in combination with one or more applications or services. Applicable triggers may be based on context. In addition, a trigger might be used to receive presence information from a plurality of presentities 101 and/or to provide presence information to a plurality of watchers 103.

As an example, the watcher 103 might have previously determined that the presentity's willingness presence aspect has a value that indicates that the presentity 101 is currently unwilling to communicate. The watcher 103 might wish to know if the presentity 101 becomes willing to communicate at a later point in time. The watcher 103 could establish a trigger on the PAL 102 requesting to be notified of a change in the presentity's willingness presence aspect. The PAL 102 would then monitor the presentity's willingness presence aspect and would inform the watcher 103 if that presence aspect changed from “unwilling” to “willing”.

The use of the PAL 102 does not necessarily preclude the presence server 106 sending the presence document to the watcher 103. For example, if the watcher 103 wishes to obtain a large amount of presence information, there may be circumstances in which it is more efficient for the watcher 103 to parse the entire presence document received from the presence server 106 rather than processing multiple individual presence aspect values received from the PAL 102. The PAL 102 provides an upgrade option that might be used to hide complexity from the watcher 103 in some, possibly most or even all, circumstances.

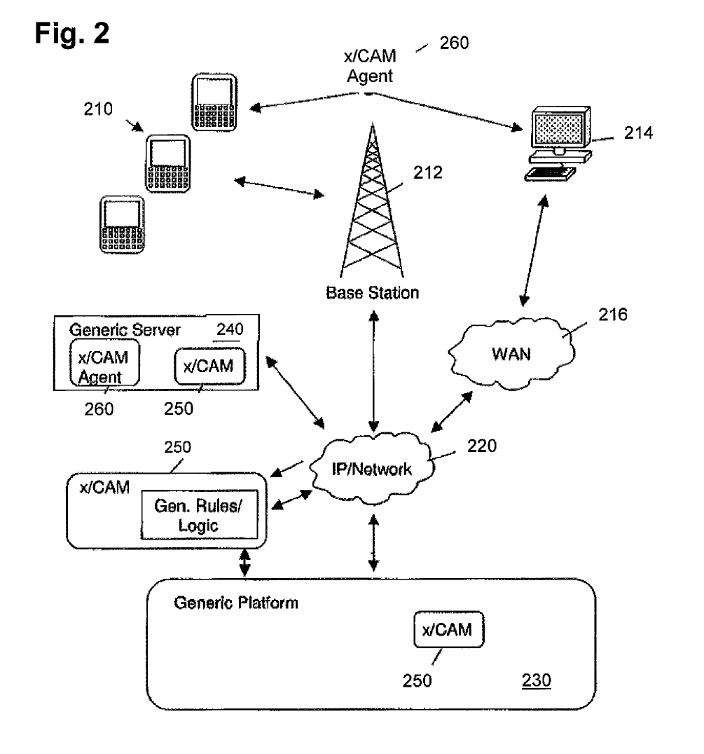

The above discussion was intended to provide sufficient information to promote an understanding of presence information in general and the presence access layer in particular. While the PAL may be employed in various systems (e.g., system 100 shown in FIG. 1) that use presence information, this disclosure does not require a PAL. Other, more generic or more specific systems may work with presence information, for example, as shown in FIG. 2.

FIG. 2 is a block diagram showing an example system in which a context aware mechanism (CAM) has been added according to an embodiment of the disclosure. The embodiment shown in FIG. 2 can represent an exemplary implementation of system 100 of FIG. 1. A PAL 102, or p/CAM, is a presence-related x/CAM, with the term x/CAM referring to a more generic context aware mechanism. The x/CAM 250 shown in FIG. 2 may be configured on one or more system elements, possibly distributed as shown in FIG. 2. Additionally, one or more x/CAM agents 260 may be configured on one or more system elements. An x/CAM agent 260 may be self contained software or hardware on a server or a user agent, as opposed to being distributed among multiple systems. x/CAM 250 and x/CAM agents 260 are described further below.

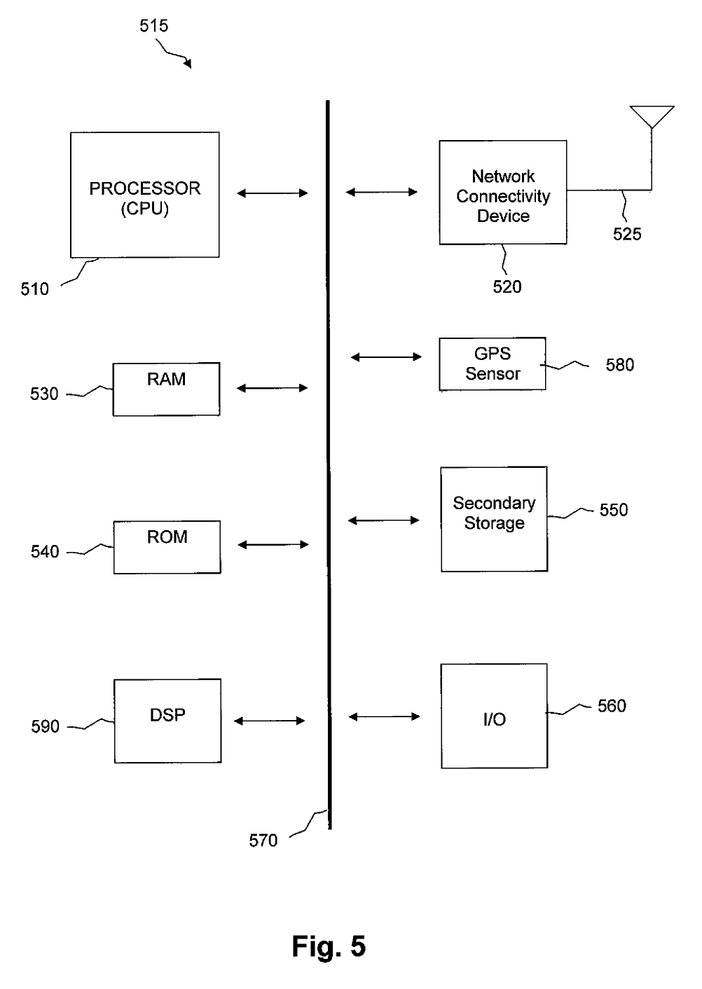

Applications possess functional utilities that have important characteristics known as context. Context is defined as “the set of information which surrounds, and gives meaning to something else.” Examples of context can be found, for example, in presence applications, location applications, among others. Context can be quantitatively represented by data stored as one or more files or databases on one or more computer readable medium, such as but not limited to RAM 530, ROM 540, Secondary Storage 550 of FIG. 5, or on a tangible storage medium, which may include optical disc drives (CD, DVD), flash drives, hard disk drives, RAM, ROM, and many others.

With regard to presence information, presence metadata provides meaning and the presence information is the basis of the context. The meaning is applied to or part of a particular function or a particular feature of a function within an application to establish an appropriate set of processing steps.

Presence context determines what presence information is relevant. For example, if a presence context is for an instant messaging service, that context may establish that only “willingness” and “availability” are significant. In contrast, a presence context for a VoIP (voice over Internet call control) may establish that “willingness” and “contactable” are relevant. Presence context is based on factors such as, but not limited to service identification, identity of the watcher, a group to which the watcher belongs, and others. The resolution for the presence context is what establishes meaning in terms of how presence information is processed.

In one example, an instant message (IM) client application operable on a first user's mobile device may require functionality to establish whether other individuals or peers are reachable to permit the first user to initiate an IM chat session. It is also possible that within an IM client, functionalities are required to establish a peer user status icon to represent a second user. In the first scenario, context relates to whether the second user is reachable to initiate a chat. In the second scenario, the first user's IM client discriminates and derives a status icon based on the second user's status and availability to display the correct status icon, indicia or avatar. In the context of the IM client, reachability as it relates to peer status icon feature may not be relevant, whereas reachability is helpful for facilitating the initiated chat function.

The above demonstrates, in a presence environment, that context plays a significant role in computing an individual's presence information to derive presence related aspects, including reachability, availability, among others. As will be appreciated, context also applies in other scenarios besides presence. For example, for a location, a relevant aspect may be based on an underlying “presence aspect” which relates to “who is nearby.” This aspect would allow a user on a device to establish whether one of his or her friends is in close physical proximity.

A presence service (such as but not limited to presence server 106 and presence access layer (PAL) 102 of FIG. 1) captures presence information from one or more presence sources (such as but not limited to presentity 101 of FIG. 1). Once this data is collected, a presence service composes or transforms the captured metadata and distributes a raw presence metadata document to authorized watchers (such as but not limited to watcher 103 of FIG. 1). An OMA-Presence service platform is a demonstrative example of a presence service. The OMA-Presence enabler outlines, in detail, semantics and policy related to the publication and consumption of presence information.

Returning to FIG. 2, user devices 210 communicate through a base station 212 with a network 220. Further, a desktop 214 (e.g., a computing device that is similar or different than user devices 210) communicates through a wide area network 216 with network 220. Also, a generic platform 230 is adapted to store data and states for various devices. Other servers such as a generic server 240 can exist within the network and can communicate over network 220.

The x/CAM 250 may be configured on one or more system elements, and may be distributed as shown in FIG. 2 and as further described below. The x/CAM 250 is adapted to communicate with network 220 and with or as part of generic platform 230. In other embodiments, the x/CAM can be located on server 240. In yet further embodiments, the x/CAM can have x/CAM agents 260 (e.g., client applications) that are located on user devices 210, 214 or on server 240 (e.g., server applications), respectively. In still further embodiments, the XICAM can be part of the generic platform 230. Thus, an x/CAM may be located as part of a generic platform 230, which might be a horizontal platform such as ‘presence’ or ‘location’ services or some other more generic platform. Additionally, an x/CAM located on devices (such as x/CAM agent 260) can be a completely self-contained x/CAM. Still further, an x/CAM agent located on one or more devices could work in concert with any of the x/CAMs shown. Further still, an x/CAM agent 260 located in a server, such as an instant messaging server or server 240, could be provided without x/CAM 250. Additionally, a combination of x/CAM agents and/or x/CAMs could be located in one or more servers (such as a self contained push-to-talk server), such as in generic server 240.

Thus, FIG. 2 illustrates abstracting a platform, whether it be presence, location, generic or a combination of the previous, to a context aware layer using context aware mechanisms or layers to support a multiplicity of application types or enablers. These techniques may be implemented utilizing policies and rules/triggers.

In accordance with one embodiment, a context or mechanism, whether it is presence, location or generic, may include one or more of policies, aspects, rules and triggers. A policy is associated with a particular presence context at an appropriate point in the application life cycle, to specify the behavior or treatment of presence, location or generic related aspects. Policies augment rules/logic flows by the manner in which they operate, to provide a more accurate and meaningful computation of aspects on behalf of a client application or enabler. As will be appreciated, a policy can apply to a class of applications, an individual application or even to a user and can be provisioned with settings regarding a manner in which aspects are computed.

Policy may be expressed using the Open Mobile Alliance (OMA) policy evaluation, enforcement and management (PEEM)/policy expression language (PEL). PEL defines a generic and extensible grammar in which policies may be expressed using a rule set language. PEL is based on Internet Engineering Task Force (IETF) request for comments (rfc) 4745. Conditions and/or actions (as specified in rfc 4745) may be enhanced within the scope of PEEM, through the OMA XDM (XML Document Management) common policy extensions, as detailed in OMA_SUP_XSD_XSD_xdm_extensions_V1_{—}0. The policy can also be expressed as in IETF rfc 4745. As will be appreciated, PEEM is a continuing standards effort by the OMA to define common functions needed by its enablers.

A relevant presence policy, for use by a presence context in the computation of presence aspects, could be an “opt-in-source” policy. This policy may indicate which presence element is an indicator of service opt-in. Two possible values could be “willing” and “ignore.” In an embodiment, the default value is “ignore,” which indicates that opt-in is not relevant for the given communication service. This exemplary policy, or some other policy, may have applicability to an OMA presence platform. The opt-in-source policy is meant as an example only; other policies are possible based on the needs of a system or user.

By extending common policy actions, x/CAM policies may be incorporated into a common policy PEL ‘ruleset’ XML document. A ‘ruleset’ may apply at a user scope or a global scope. For example, the ‘ruleset’ may apply to a class of service or a specific application. The ruleset may also apply to an individual user or group of users.

x/CAM related policies are referenced, resolved, and/or evaluated through the various PEEM requestor interfaces by the x/CAM server itself or a x/CAM enabled client/agent. That is, application or authentication protocols may provide specific metadata such as the requestor identity to the PEEM requestor interface, along with other metadata available to the PEEM servers as the basis for applying rules.

An example of a common policy PEL rule set XML document includes a single rule ‘a101’. This rule associates with a service enabler such as a PoC alert and defines specific policy settings/values be applied as a result of a match for a target resource. In this case, the target resource is the service identifier itself. This example makes an intentional correlation between the value of the common policy extension ‘ext:service[@enabler]’ attribute and the OMA PoC alert service-id as defined by OMA presence.

x/CAMs 250, 255, and 270 from FIG. 2, as well as a PAL (such as PAL 102 of FIG. 1, which may be configured as a PAL server in the network and a PAL client on a user device/equipment), can be implemented as a computer program product stored on a computer readable medium and executed by one or more processors, such as processing modules or units that are configured in servers or other computers. These x/CAMs can also be implemented as pure hardware or a combination of hardware and software.

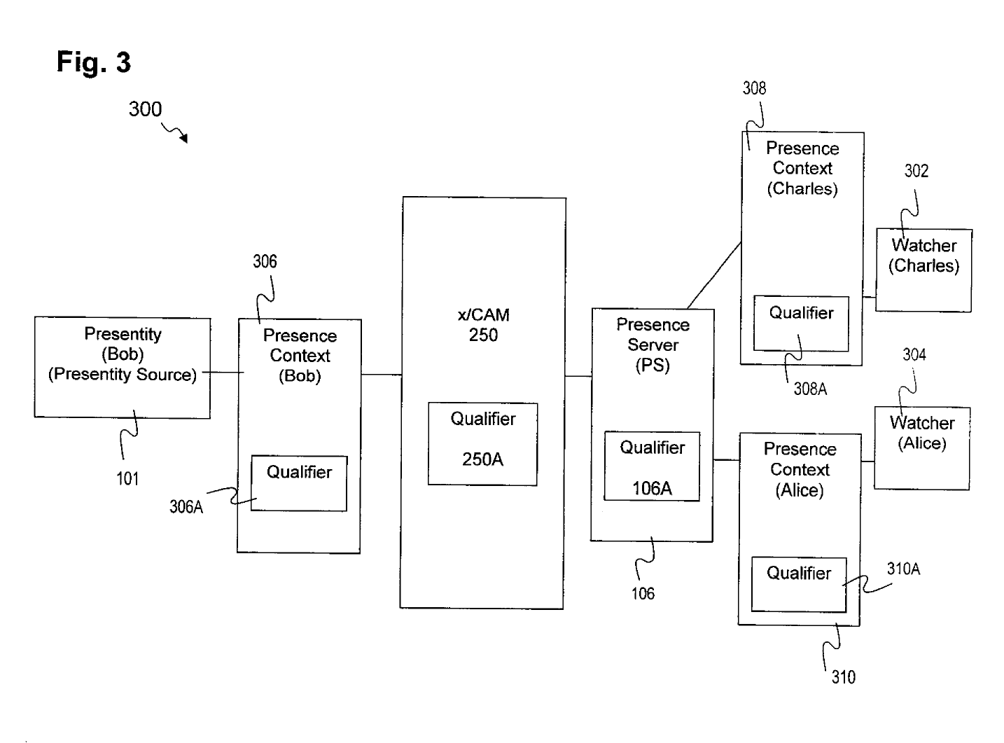

FIG. 3 is a block diagram of a communications system according to an alternative embodiment of the disclosure. The embodiments shown in FIG. 3 are extensions of the embodiments shown in FIG. 1 through FIG. 2; thus, elements common to FIG. 1 through FIG. 2 have similar reference numerals.

In the embodiments presented with respect to FIG. 3, mechanisms and methods are presented for the presentity and/or watcher(s) to qualify or authorize the other entity (presentity or watcher) by time, frequency, or other factors. Thus, the embodiments described with respect to FIG. 3 add, for example, a time-based notion to the context aware mechanism described with respect to FIG. 2 and to the presence systems described with respect to FIG. 1 through FIG. 3. In particular, time, frequency, incremental versus new and other factors can be used to limit or provide more flexibility in determining the information that will be shared. These factors may be referred to as qualifiers.

Qualifiers, including weight factors such as an interest level (also referred to hereinafter as level of interest) and a priority level, may further refine responses to requests or information provided to a watcher relative to a presence context, by adding additional information to qualify or otherwise establish, specify or define a quantity and/or frequency of information that is actually delivered to a watcher, presentity and/or x/CAM 250 from the Presence Server 106. This process of qualifying provides a valuable service for mobile presence determination, which is to increase wireless efficiency and reduce required processing power. The number of notifications can also be reduced. Additionally, qualifiers may also narrow the delivery of information for other reasons. For example, security may be provided via qualifiers. A qualifier may be used to limit information transmitted to one or more watchers depending on identity, group affiliation, or any other factor.

Returning to FIG. 3, system 300 includes presentity 101, watcher 302, watcher 304, and a presence server (PS) 106. The system 300 also includes an x/CAM 250, as described with respect to FIG. 2. In some cases, x/CAM 250 may be a PAL 102, as described with respect to FIG. 1. The presence server 106, x/CAM 250, and other features are shown inter-connected and communicating with the presentity 101 and watchers 302 and 304. It should be understood that these systems may be directly or indirectly connected and/or in communication with any other system or entity shown. Further, actions discussed as being performed by any one of the x/CAM 250, a PAL, or presence server 106 may be performed by any of these systems or combinations of these systems, in other embodiments.

In an embodiment, each of presentity Bob 101, watcher Charles 302, and watcher Alice 304 are associated with a corresponding presence context. Thus, for example, presentity Bob 101 is associated with presence context (Bob) 306; watcher Charles 302 is associated with presence context (Charles) 308; and watcher Alice 304 is associated with presence context (Alice) 310. The presence context is established by the x/CAM/PAL/PS. Presence context can take the form of data having any suitable data structure, such as but not limited to a list, array, database, or others.

Presence context metadata may be used to specify inputs relating to the establishment of a presence context (306, 308, and/or 310). Presence context metadata can be specified by a presentity or watcher, while other presence context metadata may be determined based on other information sources (e.g. information relating to a presentity or information established by third parties). Presence context metadata can take the form of a list, array, or any other suitable data structure.

While FIG. 3 shows each of presence context (Bob) 306, presence context (Charles) 308, and presence context (Alice) 310 as separate entities, in other embodiments each corresponding presence context could be represented by a single presence context. For example, a presence context could be associated with presentity Bob (306), watcher Charles (308), and watcher Alice (310). It is possible for a presence context to be unique (to a given system participant) as shown in FIG. 3, or for system participants to share a common presence context.

In addition, other criteria relating to qualifications, such as but not limited to time, frequency, level of interest, level of priority, incremental versus new, and others, may be used to specify, define or determine a quantity or frequency of information that is returned relative to a request, or relative to presence context. Presence server 106 and x/CAM 250 can use context and qualifiers according to rules and/or policies associated with the context in order to provide presence data to one or more of watcher Charles 302 and watcher Alice 304. As described above, presence data relates, for example, to availability, contact information, or other data regarding time, place, or equipment used by a presentity.

As mentioned above, qualifiers allow for the delivery, to the x/CAM and resultantly to the watcher, of a more narrow or focused set of presence information such as a value of a presence aspect. Qualifiers may provide additional parameters to the x/CAM 250 or presence server 106. These additional parameters can be used to determine at least one of what, where, when, how, how much detail (granularity) and how often (throttling) presence information regarding a presentity is to be transmitted to the x/CAM 250 and/or a watcher. A qualifier may be part of a context, such as any of presence contexts 306, 308, and 310; however, a qualifier may also be a separate data entity (e.g., a parameter or information element in a request for a specific presence aspect) that possibly refines data that is communicated to the relevant entity such as: a presence aspect value sent to a watcher; or presence information sent to the x/CAM 250 from the Presence Server 106.

The embodiments provide for one or more mechanisms with which to specify qualifiers such as, but not limited to, time, frequency, and incremental versus new (during a specified time period) for the delivery of information (in the form of aspects and triggers) on behalf of an interested third party. For example, an interested watcher, which may be a supervisor, may only be interested in a presentity, which may be as a managed worker, during business hours. A rule representing this interest could be reflected within a context relating to that particular watcher and/or the service(s) the watcher makes use of in order to narrow the band of observation of the presentity. Therefore, a qualifier relating to a specified time range is applied in this scenario.

Further examples of additional qualifiers include an associated level of interest (interest level), a level of priority (priority level) or a qualifier based on an incremental versus new within a time period. For example, through a rule associated with a trigger, a watcher may only be interested to be notified upon monitoring/detecting when some aspect of a presentity both changes and/or changes by a particular amount. In this way, the watcher only receives information on a qualified basis. A more specific example could be a unit of work that a person is performing on behalf of the watcher. In this manner, when any progress, or a certain level of progress, is detected, a trigger fires and a corresponding action (e.g., communicating a notification) is initiated.

Using a direct or derived qualifier, a watcher may indicate, based on closeness or associated level of interest to a presentity, that the watcher should receive notifications that contain additional or less detail (information granularity) about the presentity. For example, when a watcher has specified a high level of interest (e.g., very interested) in a presentity, this may cause the watcher to receive more detailed information in notifications regarding the associated presentity. However, when lower levels of interest (e.g., moderately interested, less interested, etc.) are derived, indicated or otherwise specified by a watcher relative to a given presentity, these lower levels of interest may cause the watcher to receive less detailed information updates.

If the qualifier is frequency-based then, in an embodiment, updated presence information is provided by x/CAM 250 and/or presence server 106 based on a frequency specified by the watchers. Updated presence information might be modified by various weighting factors, as described further below. For example, watcher Charles 302 could specify that Charles receive each of two types of presence data (availability and location) every 15 minutes. However, due to weighting factors, rules, and policies, watcher Charles 302 actually receives only availability information every 30 minutes. Likewise, watcher Alice 304 could specify that Alice receive one of two types of presence information every hour. However, due to weighting factors, rules, and policies, watcher Alice 304 actually receives both availability and location information every 20 minutes.

The above example is related to the use of frequency as a qualifier for presence context used in the presentation of presence data. Another exemplary qualifier is the use of time with an associated weighting factor. For example, presence context (Bob) 306 could include data that specifies that presence data regarding presentity Bob 101 should only be available during normal business hours. In this case, a weighting factor during business hours could be 1.0 (the highest rating), but the weighting factor outside business hours could be 0.0 (the lowest rating). Weighting factors regarding time could be varied during various times of day. For example, at 10:00 a.m., presentity Bob 101 is highly available to all watchers, at 2:00 p.m. presentity Bob 101 is moderately available to some watchers, and at 6:00 p.m. presentity Bob 101 is available only to select watchers.

In a similar manner, each of the watchers could specify time-based qualifiers. For example, watcher Charles 302 could specify that presence data be provided about presentity Bob 101 at certain (qualified) times of day. X/CAM 250 and/or presence server 106 would take this request, as well as all of the other rules and policies, into account when determining whether the presence information is to be provided to watcher Charles 302, as well as the type of presence information to provide.

Another qualifier could be an associated level of interest. Thus, for example, watcher Charles 302 could indicate an urgent interest in presence data concerning presentity Bob 101. Watcher Alice 304 could indicate a moderate interest. Furthermore, presence context (Bob) 306 could also specify Bob's interest in one or both of watcher Charles 302 or watcher Alice 304. These qualifiers can all be represented as weighting factors in conjunction with corresponding presence contexts, such as presence context (Bob) 306, presence context (Charles) 308, and presence context (Alice) 310. x/CAM 250 and/or presence server 106 can then use an associated level of interest in determining whether the presence information is to be provided to the watcher or watchers, as well as the type of presence information.

Another qualifier is “incremental versus new,” which might be represented by a weighting factor, by a rule, and/or by a policy specified in conjunction with a presence context. For example, watcher Alice 304 might be a supervisor and presentity Bob 101 might be responsible for a particular project. Watcher Alice 304 might specify that updated presence information regarding Bob should be presented to Alice only if Bob has completed some aspect of a project. That is, watcher Alice 304 considers project updates from Bob to have a higher relative priority level as compared to Bob's other aspects such as availability, willingness, contactability, etc. Also, watcher Alice 304 might further qualify, or it may be inferred from the watcher's indications, including presence context, that Alice be interrupted or notified regarding project updates for presentity Bob 101 every so often (5 minutes, hourly, etc.) until presentity Bob 101 has reported completion of the project.

Additional qualifiers may also be specified. For example, a “change in place” qualifier could be used to indicate whether the presence information should be provided to a watcher, as well as the type of presence information to provide. In a specific example, presentity Bob 101 could specify a qualifier to the effect that when Bob moves from location A to location B, then watcher Charles 302, but not watcher Alice 304, should be provided with updated presence information regarding Bob. Similarly, watcher Alice 304 could specify or provide a qualifier that requests that when Bob moves from location B to location C, then watcher Alice 304 should be provided with updated presence information regarding Bob. That is, watcher Alice 304 considers location updates from Bob to have a higher priority level relative to other aspects such as availability, willingness/opt-in, contactability, etc. Any of these qualifiers could be combined with a weighting factor in a manner similar to that provided above.

Another qualifier or rule that can be specified in a corresponding set of context data is based on the method for contacting a presentity. For example, presentity Bob 101 could specify a qualifier such that when Bob is associated a particular computer or address to which Bob is logged-on, then Bob is available to either watcher Charles 302 or watcher Alice 304 for instant messaging.

Another qualifier or rule that can be specified is based on the reasons that a presentity can be contacted. For example, presentity Bob 101 could specify a qualifier such that if ‘subject matter’ relates to Project X, then presentity Bob 101 will be more available to watchers specifying that the ‘subject matter’ involves Project X. In another example, watcher Alice 304 could specify a qualifier such that if presentity Bob 101 is somehow associated with Project Y, then the frequency of presence information updates corresponding with presentity Bob 101 shall be higher (i.e. more frequent). Other qualifiers or rules can be specified that either push or pull presence data via the presence access layer 102 and/or presence server 106, according to the context data associated with one or more of presence context (Bob) 306, presence context (Charles) 308, and presence context (Alice) 310. Additionally, these or other qualifiers may be combined.

Qualifiers may be implemented using a number of different techniques. A qualifier may be metadata or other data associated with or transmitted with a context of a watcher or a presentity. A qualifier may also be separate from and independent of context data. A qualifier may refine context data, or be treated independently during processing by x/CAM 250. A qualifier may be transmitted or generated by any of the watchers (302, 304), presentity (101), presence server (106), and/or x/CAM (250), or may be passed on an ad-hoc basis as part of an independent presence request or a request for a presence aspect.

In a specific example, presence context (Bob) 306 may include qualifier 306A. Similarly, presence context (Charles) 308 may include qualifier 308A and presence context (Alice) 310 may include qualifier 310A. However, these or other qualifiers may be separate and independent from presence context. Additionally, qualifiers may also be part of rules, policies, and/or triggers, or a qualifier may itself be a rule, policy, or trigger. Qualifier 250A may be included in x/CAM 250 and qualifier 106A may be included in presence server 106. Any of qualifiers 306A, 308A, 310A, 102A, 106A, and 250A, or combinations thereof, may be taken into account when processing presence data.

As also described in part above, one non-limiting technique for implementing qualifications or individual qualifiers is to use weighting factors. In an embodiment, a weighting factor may be a number between 0 and 1, with numbers closer to 1 reflecting a higher importance, though different weighting factor schemes could be used. In one embodiment, presentity Bob 101 may specify as part of a qualifier, one or more weighting factors associated with particular watchers and times. For example, presentity Bob 101 could specify qualifiers which associate a weighting factor of 0.2 to Charles and a weighting factor of 0.9 to Alice. As a result of these qualifiers, requests for information by Charles are given lower importance than requests for information by Alice. This embodiment allows for more control of one or more of the level of detail (granularity), the frequency (throttling) and priority that information is provided, for example to different watchers.

Furthermore, each watcher can specify as part of a qualifier a weighting factor that reflects the frequency that they desire presence information regarding Bob. For example, watcher Charles 302 could have a weighting factor of 1.0 to reflect the fact that Charles has a relatively urgent requirement to be updated as to Bob's presence and availability, whereas watcher Alice 304 could specify as part of a qualifier a weighting factor of 0.5 to indicate a more moderate requirement to be updated regarding Bob's presence and availability. The weighting factor may additionally or alternatively reflect a frequency of updates, a quantity of information, specified subset of information or level of information relative to a presentity and/or a context. For example, a watcher may specify a priority level value that is one of high, medium and low priority, which results in the watcher receiving specific presence information on a frequency basis. That is, a high priority level (which may be indicated by a priority weighting factor in the range of about 1.0 to about 0.7) may cause a watcher to receive more frequent updates for the presentity, whereas a medium priority level (which may be indicated by a priority weighting factor in the range of about 0.7 to about 0.4) may cause a watcher to receive medium frequency updates for the presentity, and a low priority level (which may be indicated by a priority weighting factor in the range of about 0.4 to about 0.1) may cause a watcher to receive low frequency updates for the presentity.

In another embodiment, weighting factors, in addition to those associated with qualifiers, could be used to further vary the presence data output of a context aware mechanism. For example, a rule or policy could be partially or completely implemented by referring to a weighting factor. Also, a weighting factor might be applied to sources of data (such as but not limited to sources relating to presence or location) to reflect that certain sources of presence data are more reliable than others, or at least are to be given more weight than others.

Thus, x/CAM 250 and/or presence server 106 process received data according to qualifiers, weighting factors, rules, triggers, and/or policies. As a result, presence information related to presentity (Bob) 101 is presented to watcher Charles 302 and watcher Alice 304 in a manner and at times that best satisfies all of the parameters specified by the different rules, qualifiers, weightings, triggers, and/or policies.

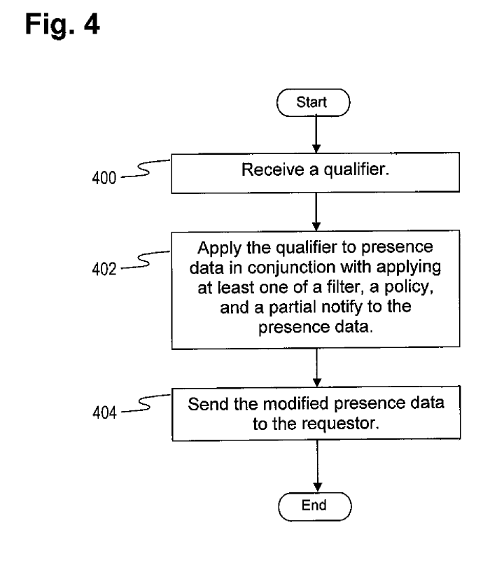

FIG. 4 is a flow chart of a method for processing context data in a context aware mechanism according to an embodiment of the disclosure. The process described with respect to FIG. 4 can be implemented in a presence server, such as presence server 106 of FIG. 1, in a presence access layer, such as presence access layer 102 of FIG. 1, or in an x/CAM 250, such as those shown in FIG. 2 or FIG. 3. The method described with respect to FIG. 4 may be implemented in a computer using one or more processors, such as those disclosed in FIG. 5.

The process begins as a qualifier is received (block 400). The qualifier may be received from a logical entity (e.g., watcher or presentity) at the PAL 102 or x/CAM 250. However, the qualifier may be received at the Presence Server 106 from the PAL 102 or x/CAM 250. The qualifier is then applied or otherwise used (block 402), for example in conjunction with an information regulator (i.e., the Presence Server) by applying at least one of a filter, a throttle, a policy, and a partial notify to establish second presence data. Alternatively, the qualifier is applied to first presence data in conjunction with applying at least one of a presence context or presence context metadata that was used to establish, specify or define the presence context, a policy, and a rule to the first presence data. In either case, applying this qualifier generates second presence data that is qualified according to application of the qualifier and the at least one of the set of criteria described above to the first presence data. The second, modified presence data is then sent to the requestor (block 404). The process terminates thereafter.

In an embodiment, the computer performing the method may be one of an Open Mobile Alliance (OMA) presence server, an OMA Location in Session Initiated Protocol/Internet Protocol core network (LOCSIP) location server, and an OMA Secure User Plane Location (SUPL) server. The qualifier may be associated with a user agent, and may even be received or sent by the user agent.

A partial notify may be a subscribe message comprising an accept header that includes instructions for sending modified presence data only when a change occurs in the presence data, or may be some other partial notify known in the art. The filter may be a rule, or may be implemented within a subscribe message from a watcher. The throttle may limit the rate of notifications, for example to a watcher.

A qualifier may be any of a time qualifier, a frequency qualifier, an incremental versus new qualifier, a weighting factor, a level of interest qualifier, a level of priority qualifier, a change of place qualifier, a qualifier that specifies a manner in which a presentity can be contacted, and a qualifier that specifies a reason for which a presentity can be contacted, or combinations thereof. Applying, as in block 402, may be performed by one of a generic context aware mechanism (x/CAM) executing on the computer, an OMA SIMPLE Presence Server and a Open Mobile Alliance Presence Access Layer (OMA PAL) executing on the computer. These and other qualifiers may be independent of context data, rules, and/or policies.

In other embodiments, qualifiers may be characterized as base qualifiers which may be extended or overridden by other qualifiers. For example, a base qualifier, specified by the PAL administrator, service provider or other authorized principal. However, a user, such as a watcher, may override this base qualifier when the user requests the “willingness” of a presentity. This override may or may not have an impact on what presence information is delivered back to the user, depending on the rules used with the PAL, SIMPLE presence or x/CAM.

The UA and other components described above might include a processing component that is capable of executing instructions related to the actions described above. FIG. 5 illustrates an example of a system 500 that includes a processing component 510 suitable for implementing one or more embodiments disclosed herein. In addition to the processor 510 (which may be referred to as a central processor unit or CPU), the system 500 might include network connectivity devices 520, random access memory (RAM) 530, read only memory (ROM) 540, secondary storage 550, and input/output (I/O) devices 570. These components might communicate with one another via a bus 570. In some cases, some of these components may not be present or may be combined in various combinations with one another or with other components not shown. These components might be located in a single physical entity or in more than one physical entity. Any actions described herein as being taken by the processor 510 might be taken by the processor 510 alone or by the processor 510 in conjunction with one or more components shown or not shown in the drawing, such as a digital signal processor (DSP) 502. Although the DSP 502 is shown as a separate component, the DSP 502 might be incorporated into the processor 510.

The processor 510 executes instructions, codes, computer programs, or scripts that it might access from the network connectivity devices 520, RAM 530, ROM 540, or secondary storage 550 (which might include various disk-based systems such as hard disk, floppy disk, SIM (subscriber identity module) card, or optical disk, or other storage device). While only one CPU 510 is shown, multiple processors may be present. Thus, while instructions may be discussed as being executed by a processor, the instructions may be executed simultaneously, serially, or otherwise by one or multiple processors. The processor 510 may be implemented as one or more CPU chips.

The network connectivity devices 520 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 520 may enable the processor 510 to communicate with the Internet or one or more telecommunications networks or other networks from which the processor 510 might receive information or to which the processor 510 might output information. The network connectivity devices 520 might also include one or more transceiver components 525 capable of transmitting and/or receiving data wirelessly.

The RAM 530 might be used to store volatile data and perhaps to store instructions that are executed by the processor 510. The ROM 540 is a non-volatile memory device that typically has a smaller memory capacity than the memory capacity of the secondary storage 550. ROM 540 might be used to store instructions and perhaps data that are read during execution of the instructions. Access to both RAM 530 and ROM 540 is typically faster than to secondary storage 550. The secondary storage 550 is typically comprised of one or more disk drives or tape drives and might be used for non-volatile storage of data or as an over-flow data storage device if RAM 530 is not large enough to hold all working data. Secondary storage 550 may be used to store programs that are loaded into RAM 530 when such programs are selected for execution.

The I/O devices 560 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 525 might be considered to be a component of the I/O devices 560 instead of or in addition to being a component of the network connectivity devices 520.

Thus, the embodiments provide for a computer implemented method. A qualifier is received. The qualifier is applied to first presence data in conjunction with applying at least one of the criteria described above to the first presence data to generate second presence data. The second presence data is sent to a requestor.

The embodiments also provide for a system The system includes a processor configured, responsive to receiving a qualifier, to apply the qualifier to first presence data in conjunction with applying at least one of a the criteria described above to the first presence data to generate second presence data that is modified according to application of the qualifier and the at least one of the criteria described above to the first presence data, and wherein the processor is further configured to send the second presence data to a requestor.

The embodiments also provide for a mobile device or user agent. The mobile device includes a processor configured to transmit a qualifier, and then receive modified presence data which has been modified by applying the qualifier to first presence data in conjunction with applying at least one of the criteria described above to the first presence data.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method comprising:
receiving, at an x/CAM, a request from a logical entity that includes a qualifier, the qualifier being usable by the x/CAM to throttle frequency of notifications received from a Presence Server; and
using the qualifier.

2. The method of claim 1 wherein the qualifier is a priority level parameter.

3. The method of claim 2 wherein the priority level parameter is one of high priority, medium priority and low priority.

4. The method of claim 3 wherein the high priority is associated with a first value, the medium priority is associated with a second value and the low priority is associated with a third value.

5. A method comprising:
communicating, to an x/CAM, a request that includes a qualifier, the qualifier causing the x/CAM to throttle frequency of notifications that the x/CAM is to receive from a Presence Server.

6. The method of claim 5 wherein the qualifier is a priority level parameter.

7. The method of claim 6 wherein the priority level parameter is one of high priority, medium priority and low priority.

8. The method of claim 7 wherein the high priority is associated with a first value, the medium priority is associated with a second value and the low priority is associated with a third value.

9. A method comprising:
receiving, at an x/CAM, a request from a logical entity that includes a qualifier, the qualifier being usable by the x/CAM to manage granularity of notifications received from a Presence Server; and
using the qualifier.

10. The method of claim 9 wherein the qualifier is a level of interest parameter.

11. The method of claim 10 wherein the level of interest parameter is one of highly interested, moderately interested and less interested.

12. The method of claim 11 wherein highly interested is associated with a first value, moderately interested is associated with a second value and less interested is associated with a third value.

13. A method comprising:
communicating, to an x/CAM, a request that includes a qualifier, the qualifier causing the x/CAM to manage granularity of notifications that the x/CAM is to receive from a Presence Server.

14. The method of claim 13 wherein the qualifier is a level of interest parameter.

15. The method of claim 14 wherein the level of interest parameter is one of highly interested, moderately interested and less interested.

16. The method of claim 15 wherein highly interested is associated with a first value, moderately interested is associated with a second value and less interested is associated with a third value.
